(19) United States
(12) Patent Application Publication
(10) Pub. No.: US 2026/0237156 A1
(43) Pub. Date: Aug. 13, 2026

(54) BEACH DIGITAL ELEVATION MODEL GENERATION METHOD BASED ON MULTI-SOURCE DATA FUSION

(71) Applicant: Second Institute of Oceanography, Ministry of Natural Resources, Hangzhou (CN)

(72) Inventors: Lianqiang Shi, Hangzhou (CN); Zhuocheng Liu, Hangzhou (CN); Junli Guo, Hangzhou (CN); Wenliang Zhang, Hangzhou (CN); Yu Peng, Hangzhou (CN); Huangzhe Qi, Hangzhou (CN)

(21) Appl. No.: 19/452,195

(22) Filed: Jan. 16, 2026

(30) Foreign Application Priority Data
Feb. 8, 2025 (CN) 202510139843.8

(51) Int. Cl. G06T 17/05; G01S 17/89; G06T 3/4038; G06T 5/70

(52) U.S. Cl. CPC G06T 17/05; G01S 17/89; G06T 3/4038; G06T 5/70

(57) ABSTRACT

A beach digital elevation model (DEM) generation method based on multi-source data fusion pre-processes, calibrates three data sources and uses appropriate interpolation algorithms to ensure the consistency in resolution and spatial reference of the three data sources; and eliminates differences in spatial reference through coordinate transformation and projection transformation. Through these measures, beach DEM data with high temporal and spatial resolution have been constructed, and finally high-precision data collection and DEM generation of beach topography have been achieved by integrating multi-source sensor technology. This method not only has important applications in traditional marine surveying and mapping, environmental monitoring and marine scientific research, but also plays an important role in disaster early warning, infrastructure construction and other fields.

### CROSS-REFERENCE TO RELATED APPLICATION

This application claims priority of Chinese Patent Application No. 202510139843.8, filed on Feb. 8, 2025, the entire contents of which are incorporated herein by reference.

### TECHNICAL FIELD

The present disclosure relates to the field of beach topography and geomorphology construction, and in particular to a beach digital elevation model (DEM) generation method based on multi-source data fusion.

### BACKGROUND

Beaches are an important part of the coastal system, and their topography changes directly affect the stability of coastline, the health of marine ecosystems and the safety of human activities. Monitoring and analysis of beach topography is of great significance to coastal engineering, environmental management, ecological protection and disaster early warning.

Although the traditional beach topography measurement method has high accuracy, it has limitations. For example, real-time kinematic (RTK) requires surveyors to set up base stations and mobile stations on the beach to carry out complex parameter setting and calibration work. At the same time, it is also necessary to pay attention to the quality and stability of satellite signals in real time. Total stations require surveyors to accurately align the target point, measure angle and distance, and manually record and process the data. In addition, these devices can only achieve single point measurement of topographic data and cannot meet the requirements for topographic data of the entire beach.

In addition, the complexity and variability of beach topography also brings considerable challenges to the measurement work. Interference from tides and sea breeze may cause errors in the measurement results. Therefore, surveyors need to constantly adjust measurement methods and device parameters to ensure the accuracy and reliability of the measurement.

At the same time, in the process of directly using three data sources, namely terrestrial laser scanners, unmanned ships and video image systems, to invert and stitch DEM, there are problems such as inconsistent resolution and spatial reference. Among them, terrestrial laser scanners have high precision and fast scanning speed, but its point cloud density is not evenly distributed in space. The single-beam echo sounder carried by the unmanned ship can obtain accurate data on underwater topography, but its resolution is closely related to the speed and water depth of the unmanned ship, as well as performance of the measuring device. Video image systems use image processing technology to extract topographic information by capturing continuous ground or water images. The resolution of video image system is limited by the camera's resolution, focal length, and environmental conditions during shooting. Therefore, the three data sources use different coordinate systems and projection methods, making it difficult to accurately align data when stitching.

Therefore, a reasonable method is needed to fuse the three types of data and an efficient method is needed to generate beach DEM.

### SUMMARY

A technical problem to be solved by the present disclosure is that the existing beach DEM generation method is labor-intensive, requires a large amount of manpower and time, and has low efficiency; it is difficult to quickly obtain large-scale beach topography data; and the spatio-temporal resolution is low, which makes it impossible to achieve data integration and stitching.

In order to solve the above technical problems, embodiments of the present disclosure provide a beach DEM generation method based on multi-source data fusion, including:
S1. obtaining a highest tide line and a lowest tide line of the beach in the near future, and extracting a shoreline at the corresponding time by using historical video image data as a boundary line for delimiting backshore, inner shore and foreshore of a study area, and determining a unified geographical coordinate system for subsequent data processing;
S2. collecting field data at low tide by using a three-dimensional laser scanner combined with RTK method to obtain foreshore point cloud data of the beach and converting the foreshore point cloud data into a first DEM;
S3. inverting inner shore topography through the historical video image data combined with shoreline method, and converting the inner shore topography to a second DEM;
S4. collecting foreshore topographic data at high tide by using a single-beam unmanned ship, projecting the foreshore topographic data to the unified geographical coordinate system in S1, and converting the foreshore topographic data into a third DEM; and
S5. using a backshore area, an inner shore area and a foreshore area as mask layers according to historical images of S1, and mosaicking and stitching the first DEM in S2, the second DEM in S3, and the third DEM in S4 according to geographical locations to finally obtain a complete beach DEM.

In some embodiments, in the beach DEM generation method, in S5, elevation adjustment is performed during stitching the first DEM, the second DEM, and the third DEM, and weight of the elevation adjustment is calculated through Formula (1),

$${R}^{2} = 1 - \frac{{\sum }_{i = 1}^{M} {( {Z}_{R T K} - {Z}_{i n t e r p} )}^{2}}{{\sum }_{i = 1}^{M} {( {Z}_{R T K} - \overline{{Z}_{R T K}} )}^{2}} \qquad ( 1 )$$

where R² is calculated by calculating the coordinates of actual measured RTK points on the beach and DEM data obtained by interpolation or inversion, Z_{RTK} is an elevation value of the actual measured RTK points, and Zᵢₙₜₑᵣₚ is an elevation value of the DEM data obtained by interpolation or inversion.

In some embodiments, in the beach DEM generation method, small pores existing during extraction of the mask layers in S5 are filled by using a closed operation method of mathematical morphology.

In some embodiments, in the beach DEM generation method, converting the foreshore point cloud data into the first DEM in S2 includes:
S21. denoising the foreshore point cloud data and filtering out data with reflectivity lower than-25 dB and waveform deviation greater than 20 in the foreshore point cloud data;
S22. stitching data from each station;
S23. converting scanner coordinates and RTK control point coordinates to geographical coordinates to place the scanner coordinates and the RTK control point coordinates in the same reference system, and removing isolated noise underwater and in air through visual interpretation; and
S24. constructing a triangulated irregular network (TIN) model, removing nails in the TIN model, and finally converting the foreshore point cloud data to the first DEM through a bin method.

In some embodiments, in the beach DEM generation method, converting the inner shore topography to the second DEM in S3 includes:
S31. collecting image correction control points by using RTK;
S32. selecting at least 5 control points, obtaining real-world coordinates and image pixel coordinates of the at least 5 control points, and calculating a conversion coefficient for converting an image from a side view image to an orthophoto image by using photogrammetry principles;
S33. applying the conversion coefficient to all images to obtain a corrected images, and stitching cameras at the corresponding time in sequence to obtain a panoramic view of the beach, and extracting the shoreline; and
S34. checking a tide level value at the corresponding time, using the tide level value as shoreline elevation, repeating the above steps, extracting all available video image shorelines within one day, and then performing spatial interpolation calculation by using elevations of the shorelines to obtain the second DEM.

In some embodiments, in the beach DEM generation method, in S4, the third DEM is obtained by using Delaunay-TIN combined with natural domain interpolation.

Through the above technical solution, the present disclosure provides a beach DEM generation method based on multi-source data fusion, which ensures the consistency in resolution and spatial reference by pre-processing, calibrating and using appropriate interpolation algorithms on three data sources, and eliminates differences in spatial reference through coordinate transformation and projection transformation. Through these measures, we have constructed beach DEM data with high temporal and spatial resolution, and finally achieved high-precision data collection and DEM generation of beach topography by integrating multi-source sensor technology. The method not only has important applications in traditional marine surveying and mapping, environmental monitoring and marine scientific research, but also plays an important role in disaster early warning, infrastructure construction and other fields. In addition, through the implementation of the present disclosure, the accuracy and real-time nature of beach topographic data can be greatly improved, and the digital management method can also improve data sharing and utilization efficiency and promote interdisciplinary research and application. In summary, the construction of beach DEM can not only meet the needs of beach management, environmental monitoring and disaster early warning, but also promote the application of digital management methods and the development of interdisciplinary research.

### BRIEF DESCRIPTION OF THE DRAWINGS

In order to more clearly explain the embodiments or the technical solutions of the present disclosure, the drawings required to be used in the description of the embodiments are to be briefly introduced below. Obviously, the drawings in the following description are only some embodiments of the present disclosure. For those skilled in the art, other drawings can also be obtained from these drawings without creative efforts.

FIG. 1 is a flow chart of a beach DEM generation method based on multi-source data fusion provided in an embodiment of the present disclosure.

FIG. 2 is a point cloud data diagram in the beach DEM generation method based on multi-source data fusion provided in Embodiment 1 of the present disclosure.

FIG. 3 is a flow chart of image processing in the beach DEM generation method based on multi-source data fusion provided in Embodiment 1 of the present disclosure.

FIG. 4 is a mask extraction diagram in the beach DEM generation method based on multi-source data fusion provided in Embodiment 1 of the present disclosure.

FIG. 5 is a DEM data diagram in the beach DEM generation method based on multi-source data fusion provided in Embodiment 1 of the present disclosure.

### DETAILED DESCRIPTION

Implementations of the present disclosure are described in further detail below with reference to the drawings and embodiments. The following detailed description of the embodiments and accompanying drawings are used to exemplarily illustrate the principles of the present disclosure, but are not intended to limit the scope of the present disclosure. The present disclosure may be implemented in many different forms and is not limited to the specific embodiments disclosed herein, but includes all technical solutions that fall within the scope of the claims.

These embodiments are provided in this disclosure so that the present disclosure will be thorough and complete, and will fully convey the scope of the present disclosure to those skilled in the art. It is noted that unless specifically stated otherwise, the relative arrangements of components and steps, compositions of materials, numerical expressions, and numerical values set forth in these embodiments are to be interpreted as exemplary only and not as limitations.

In addition, “first”, “second” and similar words used in the present disclosure do not indicate any order, quantity, or importance, but are only used to distinguish different parts. “Vertical” is not vertical in the strict sense, but within the allowable error range. “Parallel” is not parallel in the strict sense, but within the allowable error range. Words such as “include” or “contain” mean that the elements preceding the word cover the elements listed after the word, and do not exclude the possibility of covering other elements as well.

All terms used in the present disclosure have the same meaning as understood by those skilled in the art to which this disclosure belongs, unless specifically defined otherwise. It is also understood that terms defined, such as in a common dictionary, are to be interpreted as having a meaning consistent with their meaning in the context of the relevant art and should not be interpreted in an idealized or extremely formal sense unless explicitly so defined herein.

Techniques, methods and devices known to those skilled in the relevant art may not be discussed in detail, but where appropriate, techniques, methods and devices should be considered part of the specification.

### Embodiment 1

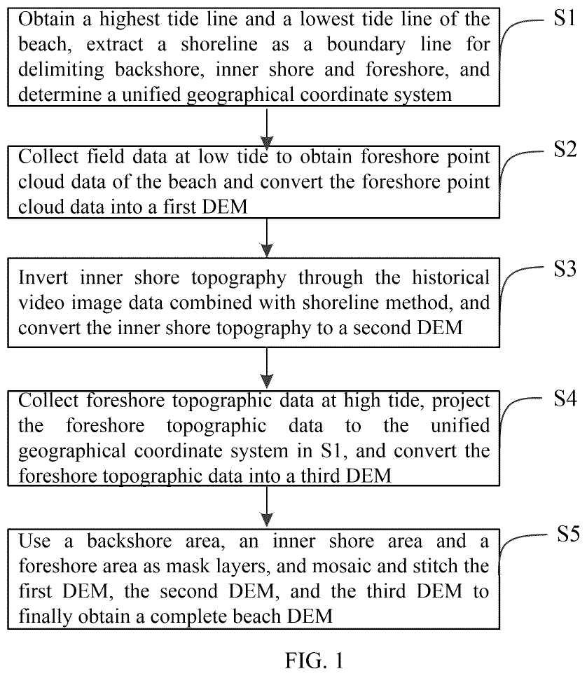

Referring to FIGS. 1-5, this embodiment provides a beach DEM generation method based on multi-source data fusion. This method is used to conduct surveys in a certain place in June 2024. In this study, the coordinate system of all data is unified: the reference ellipsoid datum is CGCS2000 (China Geodetic Coordinate System 2000), the map projection is Gauss-Kruger projection (epsg: 4550), and the elevation datum is the 1985 national elevation datum (average sea level). The method includes steps S1-S5.

In S1, the VZ-2000i ground laser scanner is first used to collect point cloud data in conjunction with Zhonghaida RTK device. On the premise of ensuring the integrity of the target point cloud data, fewer measurement stations are arranged as far as possible. In addition, in order to allow a certain degree of overlap between adjacent measurement stations to facilitate subsequent point cloud data stitching, a total of 27 stations are set up, divided into two rows, to ensure comprehensiveness of the surveys.

Specifically, a measurement method combining terrestrial laser scanning (TLS) and global navigation satellite system-real-time kinematic (GNSS-RTK) is used during acquisition. The coordinate conversion process of a single TLS measurement station is carried out through a scanner-target method. At the same time, the scanner is located in the measurement station. During conversion, the targets are evenly placed at a position about 5 m away from the scanner. Then the scanner performs environmental scanning. The targets can determine the coordinates of each measurement station. The coordinates of the targets are measured by the mobile station GNSS-RTK receiver. The above work is repeated to obtain point cloud data for the entire area.

The measured TLS coordinate data is imported into RisCAN PRO 2.15 post-processing software. First, denoising: data with reflectivity lower than-25 dB and waveform deviation greater than 20 is filtered out; then data from each measurement station is stitched. Specifically, the overlap algorithm in the software is used to automatically stitch data to achieve preliminary synthesis of the data, and then the first measurement station is fixed and feature matching planes are searched to achieve accurate registration. In order to enable the data to accurately express the geographical position, the scanner data is converted to the same reference system by referring to the coordinates of the laid control points and using geographical coordinate conversion.

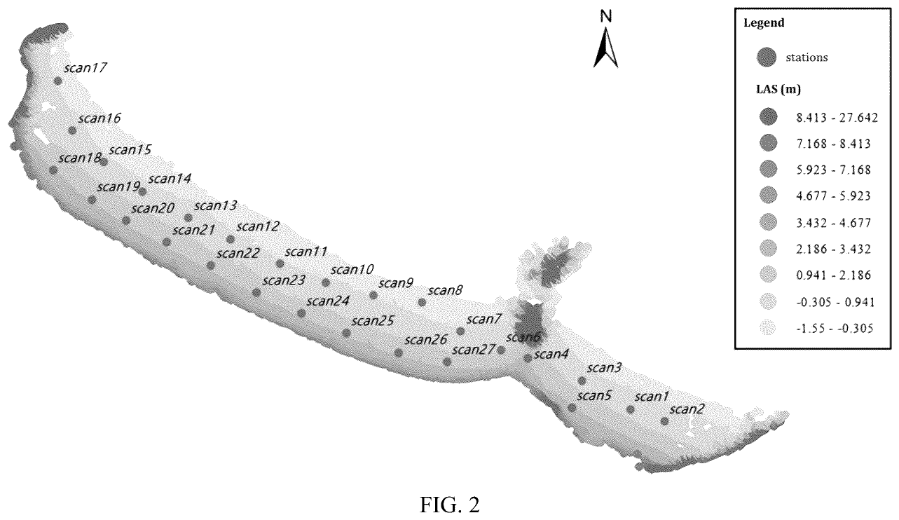

In addition, due to the existence of water on the beach surface that day, some point cloud data is mistakenly suspended below the beach surface after reflection of the laser. Such noise and some isolated noise in the air are removed through manual visual interpretation. The first DEM is then created by the bin minimum method. Finally, the grid doctor performs automatic repair to remove fine defects such as nails, small holes and non-manifolds in the results, and obtains the backshore topographic data for constructing seamless bathymetric and topographic digital elevation models (SBT-DEM) with a grid resolution of 1 m, as shown in FIG. 2. The LAS in FIG. 2 is LASer File Format.

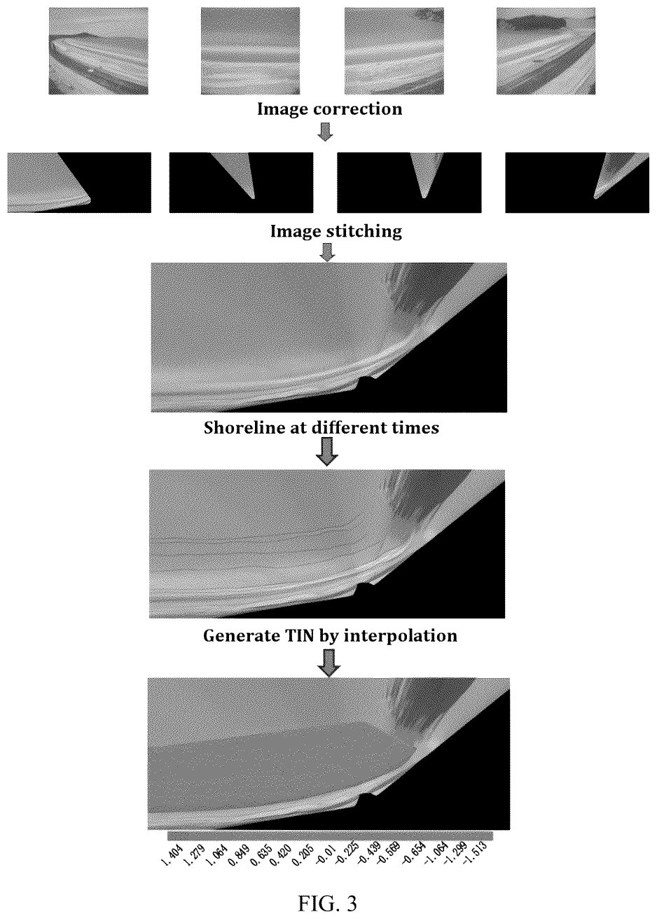

In S2, referring to FIG. 3, by writing a MATLAB program, using the real-world coordinates of the RTK control point obtained by actual measurement and the corresponding image pixel coordinates, 11 parameters for image correction are calculated, in which include 7 external parameters: the camera's three rotation angles in space Φ, σ, τ, the camera's real-world coordinates xc, yc, and zc, and the camera's effective focal length, and 4 internal parameters: the image center coordinates u0, and v0, and two scale factors λu and λv. The obtained correction coefficients are applied to the instantaneous images of several cameras at the same time to obtain the orthophoto images within the range of each camera respectively, and the images are fused and stitched to obtain a beach panoramic view of the monitored area.

Finally, Arcgis's editing function is used to draw the shoreline at different times of the day, then the tide level at the corresponding time of the tide table is checked to server as the contour elevation value of the shoreline, and the ordinary kriging interpolation method is used to interpolate to obtain the second DEM.

In S3, the nearshore water depth measurement is performed by an APACHE 6 CHCNAV unmanned surface vehicle equipped with a single-beam echo sounder, and the nearshore positioning adopts the GNSS network RTK mode. Computer control software is used to plan the navigation path of the unmanned ship, so that the unmanned ship can travel along the survey trajectory line in automatic mode. In addition, for safety reasons, a remote control is used to manually control the navigation direction of the unmanned ship in areas where obstacles may exist (such as reefs). The data measured by the unmanned ship is the geodetic height H at the seabed point. The geodetic height system uses the CGCS2000 reference ellipsoid as the datum. The 1985 national elevation system uses the average sea level as the datum, and use a formula to preform a vertical datum conversion:

$$h = H — N ; \qquad ( 2 )$$

in which h is the underwater topographic elevation under the 1985 national elevation datum, and N is the geoid undulation.

Finally, the underwater topography is constructed using Delaunay-TIN (triangulated irregular network) in ArcGIS combined with natural domain interpolation to obtain the third DEM.

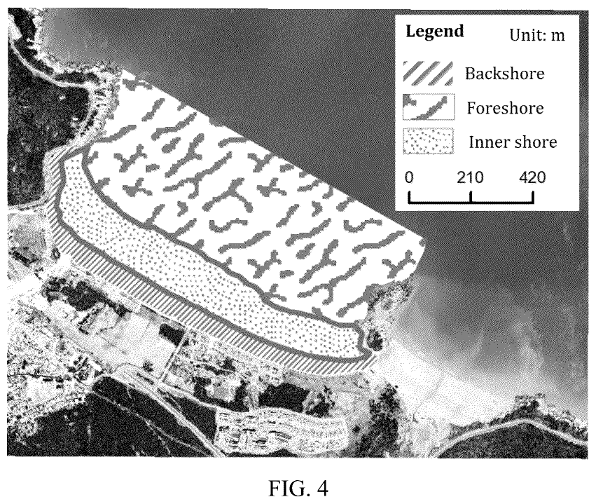

In S4, referring to FIG. 4, mask extraction is performed on the above three DEMs using the delineated foreshore, inner shore and backshore areas to obtain DEM data of the corresponding areas.

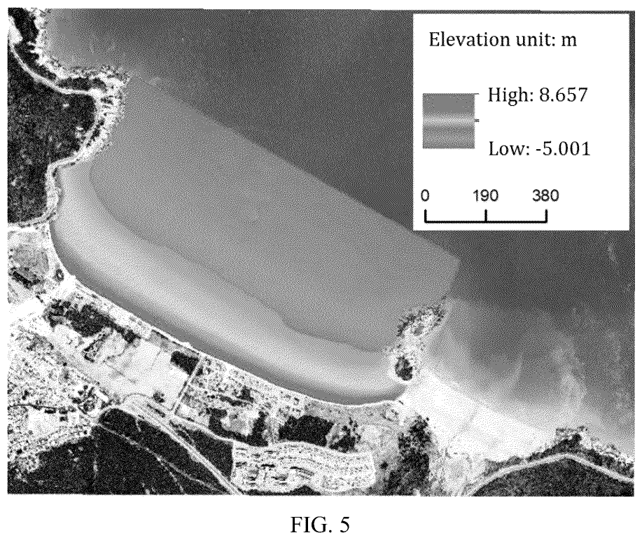

In S5, referring to FIG. 5, the R2 between the elevation data and the interpolated data of the measured RTK points is calculated.

$${R}^{2} = 1 - \frac{{\sum }_{i = 1}^{M} {( {Z}_{R T K} - {Z}_{i n t e r p} )}^{2}}{{\sum }_{i = 1}^{M} {( {Z}_{R T K} - \overline{{Z}_{R T K}} )}^{2}} \qquad ( 1 )$$

in which the greater the value of R2, the higher the accuracy of the DEM generated by this type of data, and the smaller the elevation adjustment value when overlapping pixels are encountered during stitching, so this data has more reference value. The lower left corner in FIG. 5 is the beach, and the closer to the beach, the higher the elevation.

Then the three DEM data are stitched and fused in order. In addition, due to the use of masks to extract the topography near the highest and lowest tide lines, there will be a very small number of unnecessary small pores. In order to maintain data integrity, a closed operation method of mathematical morphology is used to fill in, and the values of other areas remain unchanged. Among them, the structuring element used in the closed operation is an 8*8 circular structure. DEM data for the entire beach is obtained.

In marine surveying and mapping, this method can accurately depict intertidal topography and underwater geomorphology, providing a reliable basis for navigation safety and chart update. In terms of environmental monitoring, DEM data can quantify beach erosion and deposition dynamics and support coastline change analysis and beach restoration projects. For marine scientific research, DEM data supports coastal hydrodynamic simulation, sediment transport research, and assessment of the impact of sea level rise. In the field of disaster early warning, DEM data combined with storm surge models can accurately simulate the inundation range and improve coastal flood disaster forecasting and emergency response capabilities. In infrastructure construction, DEM data provides accurate topographic basis for port planning, seawall design, coastal road routing and other projects to ensure project safety and economic feasibility.

So far, various embodiments of the present disclosure have been described in detail. To avoid obscuring the concept of the present disclosure, details that are well known in the art have not been described. Those skilled in the art can fully understand how to implement the technical solutions disclosed herein based on the above description.

Although some specific embodiments of the present disclosure have been described in detail by way of examples, those skilled in the art are to understand that the above examples are for illustration only and are not intended to limit the scope of the present disclosure. Those skilled in the art are to understand that the above embodiments may be modified or some technical features may be equivalently replaced without departing from the scope and spirit of the present disclosure. In particular, as long as there is no structural conflict, the technical features mentioned in various embodiments can be combined in any way.

1. A beach digital elevation model (DEM) generation method based on multi-source data fusion, comprising:
S1. obtaining a highest tide line and a lowest tide line of the beach in the near future, extracting a shoreline at the corresponding time by using historical video image data as a boundary line for delimiting backshore, inner shore and foreshore of a study area, and determining a unified geographical coordinate system for subsequent data processing;
S2. collecting field data at low tide by using a three-dimensional laser scanner combined with real-time kinematic (RTK) method to obtain foreshore point cloud data of the beach, and converting the foreshore point cloud data into a first DEM;
S3. inverting inner shore topography through the historical video image data combined with shoreline method, and converting the inner shore topography to a second DEM;
S4. collecting foreshore topographic data at high tide by using a single-beam unmanned ship, projecting the foreshore topographic data to the unified geographical coordinate system in S1, and converting the foreshore topographic data into a third DEM; and
S5. using a backshore area, an inner shore area and a foreshore area as mask layers according to historical images of S1, and mosaicking and stitching the first DEM in S2, the second DEM in S3, and the third DEM in S4 according to geographical locations to finally obtain a complete beach DEM.

2. The beach DEM generation method of claim 1, wherein in S5, elevation adjustment is performed during stitching the first DEM, the second DEM, and the third DEM, and weight of the elevation adjustment is calculated through Formula (1),
$${R}^{2} = 1 - \frac{{\sum }_{i = 1}^{M} {( {Z}_{R T K} - {Z}_{i n t e r p} )}^{2}}{{\sum }_{i = 1}^{M} {( {Z}_{R T K} - \overline{{Z}_{R T K}} )}^{2}} \qquad ( 1 )$$
wherein R² is calculated by calculating the coordinates of actual measured RTK points on the beach and DEM data obtained by interpolation or inversion, Z_{RTK} is an elevation value of the actual measured RTK points, and Zᵢₙₜₑᵣₚ is an elevation value of the DEM data obtained by interpolation or inversion.

3. The beach DEM generation method of claim 1, wherein small pores existing during extraction of the mask layers in S5 are filled by using a closed operation method of mathematical morphology.

4. The beach DEM generation method of claim 1, wherein the converting the foreshore point cloud data into a first DEM in S2 comprises:
S21. denoising the foreshore point cloud data and filtering out data with reflectivity lower than −25 dB and waveform deviation greater than 20 in the foreshore point cloud data;
S22. stitching data from each station;
S23. converting scanner coordinates and RTK control point coordinates to geographical coordinates to place the scanner coordinates and the RTK control point coordinates in the same reference system, and removing isolated noise underwater and in air through visual interpretation; and
S24. constructing a triangulated irregular network (TIN) model, removing nails in the TIN model, and finally converting the foreshore point cloud data to the first DEM through a bin method.

5. The beach DEM generation method of claim 1, wherein the converting the inner shore topography to a second DEM in S3 comprises:
S31. collecting image correction control points by using RTK;
S32. selecting at least 5 control points, obtaining real-world coordinates and image pixel coordinates of the at least 5 control points, and calculating a conversion coefficient for converting an image from a side view image to an orthophoto image by using photogrammetry principles;
S33. applying the conversion coefficient to all images to obtain corrected images, stitching cameras at the corresponding time in sequence to obtain a panoramic view of the beach, and extracting the shoreline; and
S34. checking a tide level value at the corresponding time, using the tide level value as shoreline elevation, repeating the above steps, extracting all available video image shorelines within one day, and then performing spatial interpolation calculation by using elevations of the shorelines to obtain the second DEM.

6. The beach DEM generation method of claim 1, wherein in S4, the third DEM is obtained by using Delaunay-TIN combined with natural domain interpolation.
